(19) United States
(12) Patent Application Publication
(10) Pub. No.: US 2024/0261756 A1
(43) Pub. Date: Aug. 8, 2024

(54) METHOD FOR THE MANUFACTURE OF A COMPOSITE MATERIAL FOR THE RECOVERY OF NUTRIENTS AND/OR POLLUTANTS FROM WASTEWATER, COMPOSITE MATERIAL OBTAINED AND RELATED USE

(71) Applicant: ALMA MATER STUDIORUM - UNIVERSITÀ DI BOLOGNA, Bologna (IT)

(72) Inventors: Carlotta CARLINI, Bologna (IT); Antonio PRIMANTE, Bologna (IT); Nicolas GREGGIO, Bologna (IT)

(73) Assignee: ALMA MATER STUDIORUM - UNIVERSITÀ DI BOLOGNA, Bologna (IT)

(21) Appl. No.: 18/565,382

(22) PCT Filed: May 30, 2022
(86) PCT No.: PCT/IB2022/055057

§ 371 Date: Nov. 29, 2023

(30) Foreign Application Priority Data
May 31, 2021 (IT) 102021000014195

(51) Int. Cl. B01J 20/20; B01J 20/28; B01J 20/30; C02F 1/28; C02F 1/66; C02F 101/10

(52) U.S. Cl. CPC B01J 20/20; B01J 20/28004; B01J 20/3078; C02F 1/283; C02F 1/66; B01J 2220/42; C02F 2101/105

(57) ABSTRACT

A method for the manufacture of a composite material for the recovery of nutrients and/or pollutants from wastewater, the method comprising, in succession, the following phases: supply of at least one carbonate material; supply of at least one carbonaceous material; mixing the carbonate material with the carbonaceous material to obtain a mixture; and heating the mixture to a temperature above 600° C. to obtain a composite material.

### TECHNICAL FIELD

The present invention relates to a method for the manufacture of a composite material for the recovery of nutrients and/or pollutants from wastewater, a composite material so obtained, and the related use.

### BACKGROUND ART

It is well known that wastewater cannot be returned to the environment as it is, because the final destinations such as land, sea, rivers and lakes are not able to receive a quantity of pollutants exceeding their self-purifying capacity.

Consequently, the purification treatment of urban and/or industrial wastewater is made compulsory by law and consists of a succession of several phases, or processes, during which undesirable substances are removed from wastewater, which are then concentrated in the form of sludge, resulting in a final effluent of such quality so as to be compatible with the self-purifying capacity of the receiving body such as land, lakes, rivers or seas.

The purification cycle consists of a combination of several chemical, physical, and biological processes.

The sludge from the sewage cycle is often contaminated and, therefore, must undergo a series of treatments to make it suitable for disposal, for example, in special landfills or for reuse in agriculture as it is or after composting.

The treatments that are carried out during the purification cycle are either mechanical or chemical in nature.

The latter are based on the addition of specific substances to carry out particular chemical reactions.

For example, neutralization reactions or the addition of substances to facilitate the precipitation of nutrients or polluting compounds and for disinfection belong to this category.

In detail, in addition to the removal of pollutants, the purification cycles are implemented with phases of recovery of nutrients dissolved in wastewater.

In this regard, it should be emphasized that today there is a particular need to develop procedures for the recovery of nutrients from wastewater that have a low environmental impact.

Currently, nutrients are made to precipitate by means of chemical treatment into the sludge, without being able to be effectively recovered.

This process has many drawbacks, including the fact that the extensive use of chemical substances, in addition to being harmful to the environment, has many risks to human health.

### DESCRIPTION OF THE INVENTION

In a first aspect, the aim of the present invention is to devise a method for the manufacture of a composite material for the recovery of nutrients and/or pollutants from wastewater which significantly allows reducing energy waste, has a reduced environmental impact and provides for the use of eco-friendly substances.

In a second aspect, the object of the present invention is to devise a composite material for the recovery of nutrients and/or pollutants which allows the nutrients and/or pollutants themselves to be recovered quickly and easily. In a third aspect, another object of the present invention is to devise a method for the recovery of nutrients and/or pollutants from wastewater which allows the carbon dioxide produced during the manufacturing process of the composite material itself to be used, while avoiding the release thereof into the surrounding environment.

Another object of the present invention is to devise a method for the manufacture of a composite material for the recovery of nutrients and/or pollutants from wastewater, a composite material so obtained and the related use which allow the aforementioned drawbacks of the prior art to be overcome within the ambit of a simple, rational, easy and effective to use as well as affordable solution.

The aforementioned objects are achieved by the method for the manufacture of a composite material for the recovery of nutrients and/or pollutants from wastewater having the characteristics of claim 1.

Additionally, the aforementioned objects are achieved by the composite material for the recovery of nutrients and/or pollutants from wastewater having the characteristics of claim 12.

In addition, the aforementioned objects are achieved by the use of the composite material having the characteristics of claim 13.

Finally, the aforementioned objects are achieved by the method for the recovery of nutrients and/or pollutants from wastewater having the characteristics of claim 14.

### BRIEF DESCRIPTION OF THE DRAWINGS

Other characteristics and advantages of the present invention will become more apparent from the description of a preferred, but not exclusive, embodiment of a method for the manufacture of a composite material for the recovery of nutrients and/or pollutants from wastewater, illustrated by way of an indicative, yet non-limiting example, in the accompanying tables of drawings wherein:

FIG. 1 is a graph showing the adsorption efficiency over time of phosphate ions using the composite material according to the present invention;

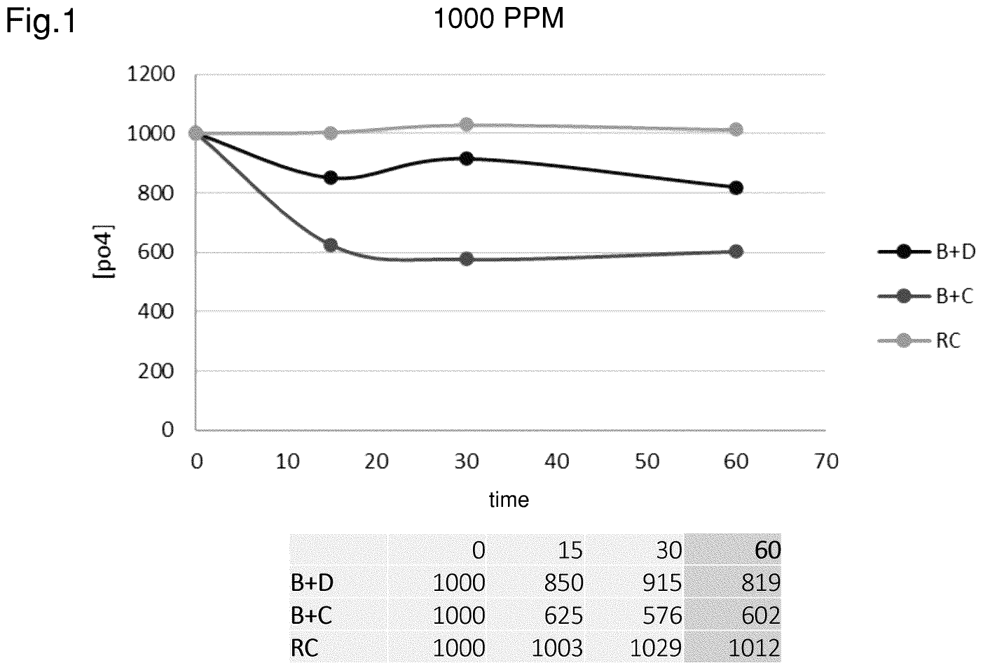

FIG. 2 is a graph showing the adsorption efficiency over time of phosphate ions using the composite material, obtained at a temperature comprised between 730° C. and 860° C., according to the present invention;

FIG. 3 represents two tables showing data on the adsorption efficiency of the composite material obtained at a temperature comprised between 730° C. and 860° C.;

FIG. 4 is a block diagram representative of the method according to the present invention.

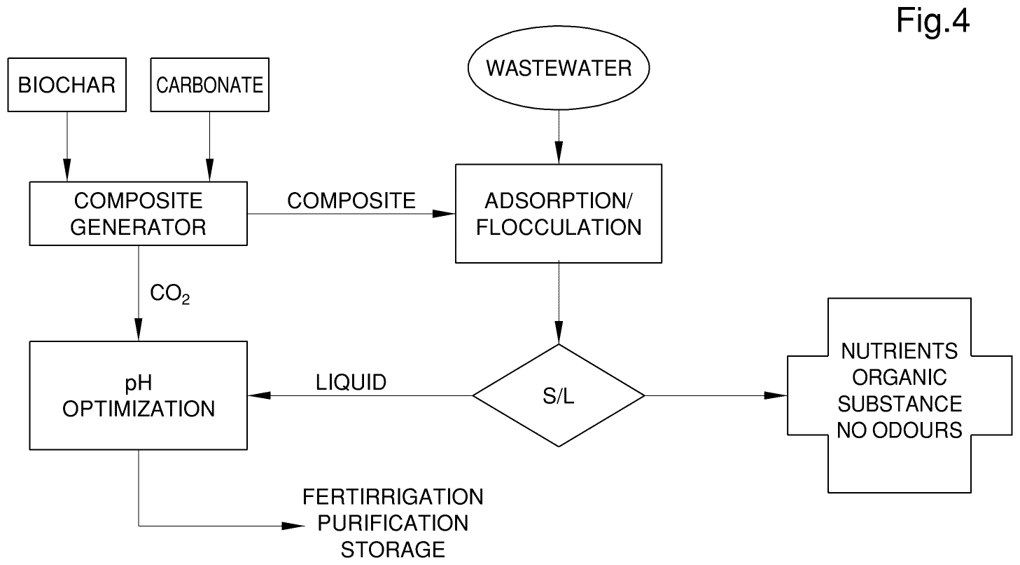

### EMBODIMENTS OF THE INVENTION

In a first aspect, the present invention relates to a method for the manufacture of a composite material for the recovery of nutrients and/or pollutants from wastewater.

It should be noted that in the present disclosure, the expression “wastewater” relates to all those waters whose quality has been impaired by anthropogenic action after their use for home, agricultural and industrial activities, thus becoming unsuitable for direct use as they are contaminated by various types of organic and inorganic substances dangerous to public health and the natural environment.

For example, this type of water may derive from contaminated sites. It is specified that the expression “contaminated site” relates to a site where the values of the risk threshold concentrations (RTC) are exceeded.

The method comprises, in succession, the following phases:
supply of at least one carbonate material;
supply of at least one carbonaceous material;
mixing of the carbonate material with the carbonaceous material to obtain a mixture;
heating of the mixture to a temperature above 600° C. to obtain a composite material.

It is specified that in the context of the present disclosure the term “carbonate material” relates to sedimentary rocks which contain more than 50% carbonate minerals, among which calcite (CaCO₃) and dolomite (Mg, Ca(CO₃)₂) predominate. Other carbonate minerals include aragonite, siderite (FeCO₃) and magnesite (MgCO₃). These carbonate rocks can be of chemical and/or biochemical origin, in the first case they result from the direct precipitation of salts from solution or due to changes in chemical and physical conditions, such as concentration, temperature and pH. In the second case they are formed when animal and plant organisms also intervene in this process.

Preferably, the carbonate material comprises one or more biogenic materials and/or one or more mineral materials.

This means that the mixture comprises a combination of one or more biogenic materials with one or more carbonaceous materials or a combination of one or more mineral materials with one or more carbonaceous materials.

It cannot, however, be ruled out from the scope of the present disclosure that the mixture comprises a combination of one or more carbonate materials with one or more mineral materials and with one or more biogenic materials.

It is specified that in the present disclosure with the expressions “one or more biogenic materials” and “one or more mineral materials” reference is made to the presence in the mixture of one or more biogenic materials and/or one or more mineral materials both belonging to the same species and/or mineralogical type, and belonging to different species and/or mineralogical type.

Advantageously, the one or more biogenic materials comprise shells and/or the one or more mineral materials comprise dolomite.

According to a preferred embodiment of the method according to the invention, the shells comprise Scallop (Pecten Jacobaeus).

In addition, it is specified that in the context of the present disclosure the expression “carbonaceous material” refers to any material obtained by thermo-chemical degradation processes such as, e.g., gasification and hydrothermal carbonization.

Specifically, the term “carbonaceous material” refers indiscriminately to char, biochar or a carbonaceous material obtained from one or more biomasses.

Preferably, the carbonaceous material is obtained by pyrolysis.

For example, the aforementioned carbonaceous material obtained by pyrolysis is produced from sewage sludge biomass.

Such sewage sludge comprises numerous waste substances, such as e.g. drug residues, micro-plastics and emerging contaminants, which are degraded as a result of pyrolysis, thus producing the carbonaceous material used.

Advantageously, one or more biomasses are obtained from or are represented by agro-forestry by-products or sewage sludge.

It should be noted that in the context of the present disclosure, the expression “one or more biomasses” refers to biomasses obtained or represented by an individual agro-forestry by-product or obtained or represented by several agro-forestry by-products or sewage sludge.

Such biomass, for example, is represented by a portion of a plant.

Preferably, according to a preferred embodiment of the method according to the invention, such biomasses are obtained from vine pruning.

Advantageously, such biomasses are obtained from vines of the Vitis Vinifera species.

The mixture comprises the carbonate material present in a concentration by weight, evaluated with respect to the total weight of the mixture, of more than 50% and the carbonaceous material is present in a concentration by weight, evaluated with respect to the total weight of the mixture, of less than 50%.

Advantageously, the carbonate material is in powdery form having an average particle size of less than 150 μm and the carbonaceous material is in powdery form and has an average particle size of between 70 μm and 200 μm.

Preferably, the carbonaceous material has an average particle size comprised between 90 μm and 180 μm.

In detail, the heating phase is carried out at a temperature above 100° C. with an increase up to a temperature above 600° C.

Preferably, the temperature is increased up to 900° C.

Conveniently, the temperature is increased up to 1,300° C.

Advantageously, the heating phase comprises an isotherm at 850° C.

Preferably, during the heating phase, the mixture is not moved.

It cannot, however, be ruled out from the scope of the present disclosure that the heating phase comprises a step of movement of the mixture.

Such movement occurs by means of a movement device, such as, e.g., an auger housed inside a heated and insulated duct. The mixture, being moved by an auger, moves inside the duct and is simultaneously heated.

In detail, the heating phase causes the calcination of one or more carbonate materials and the deposition of these substances on the carbonaceous substrate. In addition, the heating phase comprises a step of production of carbon dioxide.

Next, the process comprises a phase of granulating the composite material obtained from the method according to the present invention.

In more detail, the composite material obtained by the method according to the invention is in powdery or granular form having an average particle size comprised between 160 μm and 3 mm.

Preferably, the aforementioned composite material has an average particle size comprised between 80 μm and 2 mm.

Next, the method according to the present invention comprises at least one phase of recovery of carbon dioxide produced by the heating phase.

In this regard, the method comprises at least one phase of delivery of the carbon dioxide into wastewater.

In detail, the carbon dioxide produced as a result of heating the mixture, instead of being dispersed into the environment, is delivered into the wastewater to be treated.

This is due to the fact that the treatment of wastewater with the composite material obtained from the method according to the invention results in pH increase which can be neutralized or acidified by the addition of carbon dioxide. Furthermore, the method in accordance with the present invention is carried out in the absence of oxygen.

In a second aspect, the present invention relates to a composite material for the wastewater treatment obtained by the method described above and comprising the mixture of the carbonate material present in a concentration by weight of between 40% and 80% and the carbonaceous material in a concentration by weight of between 20% and 60%.

In a third aspect, the present invention relates to the use of the composite material for the recovery of nutrients and/or pollutants, wastewater purification.

In detail, the material in accordance with the present invention enables sequestering phosphate ions from wastewater.

Phosphorus removal is determined by the synergistic combination of precipitation of phosphorus-containing minerals triggered by calcium and magnesium metal oxides present on the carbonaceous structure of the composite material and adsorption of the phosphate anion due to electrostatic interactions between bivalent cations also present on the carbonaceous structure of the composite material.

In a further aspect, the present invention relates to a method for the recovery of nutrients and/or pollutants from wastewater.

This method comprises the phase of contacting such wastewater with the composite material in accordance with the present invention.

Next, the aforementioned method comprises a phase of adsorption of the nutrients and/or pollutants onto the composite material.

Preferably, the nutrients comprise phosphorus, nitrogen, organic carbon, humic and fulvic compounds.

Next, the method comprises a phase of separating nutrients and/or pollutants from the wastewater treated with the composite material in accordance with the present invention.

In detail, the separation phase comprises a step of solid-liquid separation wherein the composite material on which the nutrients and/or pollutants are adsorbed is removed, e.g. by filtration, from the wastewater treated with the composite material itself.

At this point, the method comprises a phase of reducing or neutralizing the pH of the wastewater by introducing carbon dioxide obtained from the manufacturing method of the composite material in accordance with the present invention.

Finally, it cannot be ruled out from the scope of the present disclosure that the invention according to the disclosure relates to a fertilizer or soil conditioner preparation comprising the previously described composite material and one or more nutrients obtained from treated wastewater.

### Example 1

The carbonaceous material obtained from pyrolysis consists of biochar from Romagna Carbone (SAMPLE RC), screened to an average particle size of between 50 μm and 500 μm.

This biochar is mixed with the carbonate material consisting of dolomite powder (sample RC+D) or shell (sample RC+C) in a proportion of between 30-70% biochar and 30-70% dolomite or shell.

The aforementioned components are mixed using a spatula.

Next, the heating phase is carried out using a muffle furnace in which the samples are subjected to a heating cycle.

During heating, the samples are subjected to an initial temperature of 105° C., increased to a temperature of between 730° C. and 860° C. in the first hour and then held constant at a temperature of between 730° C. and 860° C. for another hour, for a total of 2 hours.

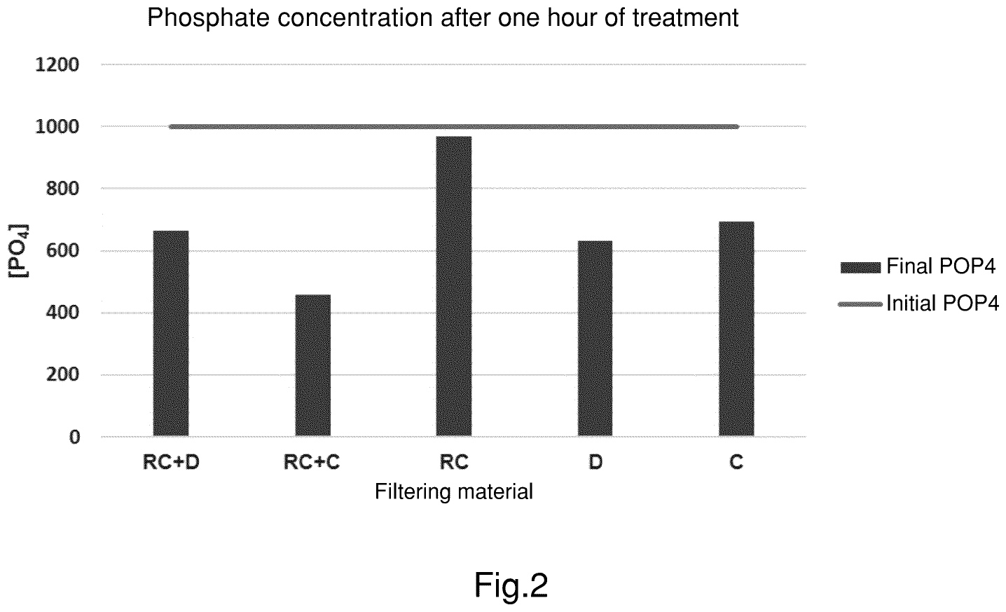

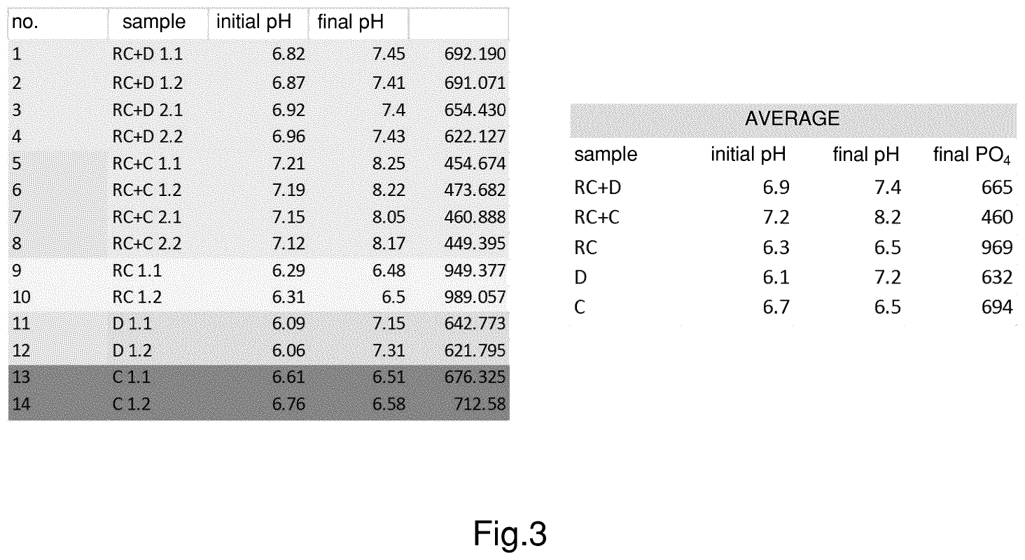

The composite material obtained, at a dosage of 1 g/l, has then been used to remove phosphate ions from a solution of KH₂PO₄ with a concentration of 1000 mg/l by tests, lasting 1 hour, carried out in a rotorbital mixer at a temperature of 25° C. (FIGS. 2 and 3).

This comparative test clearly shows that the synergistic combination of biochar and dolomite or shells surprisingly allows the recovery of phosphate ions with an adsorption efficiency significantly higher than the use of each individual heat-treated component.

This is due to the fact that the synergistic presence of the carbonate material and of the carbonaceous material, by calcining together, causes the formation of calcium and magnesium oxide crystals having dimensions considerably smaller than the crystals formed as a result of calcination of the individual components. These oxides, having dimensions in the order of nanometers, deposit on the surface of the composite material and allow obtaining greater efficiency of adsorption of the phosphate ions compared to the use of the individual components, i.e. of the carbonaceous material and of the carbonate material. From a reading of the above description of the present invention, it will be apparent to the person skilled in the art the many advantages of using the process for the manufacture of the composite material, the use thereof, and of the method for the recovery of nutrients and/or pollutants from wastewater.

First of all, being able to avoid production processes using additives or chemicals, the material is not altered and retains a complete recyclability in the environment.

It should also not be underestimated that the carbon dioxide produced during the manufacture of the composite material according to the present invention is also used in the method for the recovery of nutrients and/or pollutants from wastewater, rather than being dispersed into the environment.

Surprisingly, it was then observed that the synergistic combination of a material of carbonate origin, shells or dolomite, with a material of carbonaceous origin obtained by pyrolysis, such as biochar, allows the manufacture of a composite material that, thanks to its highly porous structure, offers a large surface useful for the adsorption of nutrients and/or pollutants on the outer structure and inside the pores.

Specifically, nutrients such as phosphorus and nitrogen and organic matter are deposited on the surface of the composite material, being sequestered and subsequently recovered by means of solid/liquid separation processes.

1. A method for manufacture of a composite material for recovery of nutrients and/or pollutants from wastewater, the method comprising, in succession, the following phases:
supply of at least one carbonate material;
supply of at least one carbonaceous material;
mixing of said carbonate material with said carbonaceous material to obtain a mixture; and
heating of said mixture to a temperature above 600° C. to obtain a composite material.

2. The method according to claim 1, wherein said carbonate material comprises one or more biogenic materials and/or one or more mineral materials.

3. The method according to claim 2, wherein said one or more biogenic materials comprise shells and said one or more mineral materials comprise dolomite.

4. The method according to claim 1, wherein said carbonaceous material is obtained by pyrolysis of one or more biomasses.

5. The method according to claim 1, wherein said heating phase is carried out at a temperature above 750° C.

6. The method according to claim 1, wherein said heating phase comprises a step of movement of said mixture.

7. The method according to claim 1, wherein said mixture comprises said carbonate material present in a concentration by weight, evaluated with respect to the total weight of said mixture, of more than 60% and said carbonaceous material is present in a concentration by weight, evaluated with respect to the total weight of said mixture, of less than 40%.

8. The method according to claim 1, wherein said carbonate material is in powdery form having an average particle size of less than 150 μm and said carbonaceous material obtained by pyrolysis is in powdery form and has an average particle size of between 70 μm and 200 μm.

9. The method according to claim 1, wherein said composite material is in powdery or granular form having an average particle size of between 160 μm and 3 mm.

10. The method according to claim 1, further comprising: at least one phase of recovery of carbon dioxide produced by said heating phase.

11. The method according to claim 1, further comprising: at least one phase of delivery of said carbon dioxide into wastewater.

12. A composite material for wastewater treatment, obtained by the method according to claim 1, said composite material comprising: a mixture of said carbonate material present in a concentration by weight of between 40% and 80% and said carbonaceous material present in a concentration by weight of between 20% and 60%.

13. A use of the composite material according to claim 12, for the recovery of nutrients and/or pollutants from wastewater, wastewater treatment, or remediation of contaminated sites.

14. The method for the recovery of nutrients and/or pollutants from wastewater, further comprising: the phase of setting said wastewater in contact with said composite material, according to claim 12.

15. The method for the recovery of nutrients and/or pollutants according to claim 14, further comprising a phase of adsorbing said nutrients and/or said pollutants onto said composite material, said nutrients comprising phosphorus, nitrogen, organic carbon, humic and fulvic compounds.

16. The method for the recovery of nutrients and/or pollutants according to claim 15, further comprising; a phase of reducing the pH of said wastewater by means of the introduction of carbon dioxide obtained from the method for the manufacture of said composite material.

17. A fertilizer or soil conditioner preparation comprising the composite material according to claim 12.

18. A method for manufacture of a composite material for recovery of nutrients and/or pollutants from wastewater, the method comprising:
supplying of at least one carbonate material;
supplying of at least one carbonaceous material;
mixing of said carbonate material with said carbonaceous material to obtain a mixture; and
heating of said mixture to a temperature above 600° C. to obtain a composite material.

19. The method according to claim 18, wherein
said one or more biogenic materials comprise shells and said one or more mineral materials comprise dolomite,
said one or more biogenic materials comprise shells and said one or more mineral materials comprise dolomite,
said carbonaceous material is obtained by pyrolysis of one or more biomasses,
said heating phase is carried out at a temperature above 750° C.,
said mixture comprises said carbonate material present in a concentration by weight, evaluated with respect to the total weight of said mixture, of more than 60% and said carbonaceous material is present in a concentration by weight, evaluated with respect to the total weight of said mixture, of less than 40%,
aid carbonate material is in powdery form having an average particle size of less than 150 μm and said carbonaceous material obtained by pyrolysis is in powdery form and has an average particle size of between 70 μm and 200 μm,
said composite material is in powdery or granular form having an average particle size of between 160 μm and 3 mm, and
at least one phase of recovery of carbon dioxide produced by said heating phase.
